(19) United States
(12) Patent Application Publication
(10) Pub. No.: US 2015/0034287 A1
(43) Pub. Date: Feb. 5, 2015

(54) HEAT EXCHANGER FOR COOLING A VEHICLE BATTERY, IN PARTICULAR FOR HYBRID OR ELECTRIC VEHICLES

(71) Applicant: Behr GmbH & Co., KG, Stuttgart (DE)

(72) Inventors: Juergen OTTO, Grossbottwar (DE); Marta LUCKA-GABOR, Bietigheim-Bissingen (DE); Katia HENDRICKX, Gerlingen (DE); Heiko NEFF, Auenwald (DE); Caroline JANZEN, Stuttgart (DE)

(21) Appl. No.: 14/451,890

(22) Filed: Aug. 5, 2014

(30) Foreign Application Priority Data
Aug. 5, 2013 (DE) 10 2013 215 358.9

(51) Int. Cl. H01M 10/613

(52) U.S. Cl. CPC H01M 10/5004
USPC 165/168

(57) ABSTRACT

A heat exchanger for cooling a vehicle battery, in particular for hybrid or electric vehicles, having at least one fluid collector made of plastic, which is connected to at least one cooling element. In a heat exchanger in which the energy efficiency of the motor vehicle is increased, the cooling element is designed as a plastic tube, in which a fluid is conducted from the first fluid collector to a second fluid collector.

This nonprovisional application claims priority under 35 U.S.C. §119(a) to German Patent Application No. 10 2013 215 358.9, which was filed in Germany on Aug. 5, 2013, and which is herein incorporated by reference.

### BACKGROUND OF THE INVENTION

1. Field of the Invention

The invention relates to a heat exchanger for cooling a vehicle battery, in particular for hybrid or electric vehicles.

2. Description of the Background Art

High-capacity batteries, such as lithium-ion batteries, are frequently used as energy storage units, for example in hybrid and electric vehicles. Lost heat, which causes the high-performance cell to heat up, is generated during the operation of high-performance cells of this type. However, lithium-ion batteries, in particular, age much faster above a design-specific temperature, so that the service life of the lithium-ion battery is undesirably shortened. To counteract this effect, cooling bodies are mounted on the lithium-ion battery.

Even the low ambient temperatures of the lithium-ion battery may greatly impair the functionality of the battery. It is therefore necessary to keep the temperature of the energy storage unit within predefined limits.

An energy storage unit is known from WO 2010/037797 A2, which corresponds to US 20110189526 and US 20110189527, and which includes a cooling body which is heat-conductively connected, at least in sections, to the flat cells of the energy storage unit. The cooling body is made of plastic, at least in areas. A cavity is provided in the cooling body, through which a coolant may flow. Moreover, each cavity of the cooling body is connected to one cooling element, which is provided between two flat cells of the energy storage unit. The energy efficiency of a motor vehicle equipped with a cooling body of this type is comparatively low.

### SUMMARY OF THE INVENTION

It is therefore an object of the present invention to provide a heat exchanger, in which the energy efficiency of a hybrid or electric vehicle is further improved.

An exemplary embodiment relates to a heat exchanger for cooling a vehicle battery, comprising at least one fluid collector, which can be made of plastic and which is connected to at least one cooling element, the cooling element being designed as a plastic tube, in which a fluid is conducted from the first fluid collector to a second fluid collector. A heat exchanger of this type, which can be made entirely of plastic, has the advantage that its weight is reduced. In particular, when using the heat exchanger in connection with lithium-ion batteries which are used in hybrid or electric vehicles, this contributes to reducing the vehicle weight. Since the vehicle weight influences the energy demand of the vehicle, in particular in urban traffic, a heat exchanger of this type, which can be made entirely of plastic, results in an improvement in the energy efficiency of the vehicle. At the same time, a heat exchanger which can be made entirely of plastic is used for electrical insulation between the individual energy cells of the lithium-ion battery, for which reason additional insulation material may be dispensed with. Dispensing with insulation material further reduces the manufacturing costs. Due to the fact that a coolant flows through the plastic tube, the setting of an optimum temperature at the lithium-ion battery is improved, which increases the service life of the lithium-ion battery.

The plastic tube can be designed as an extruded flat tube. An extruded body of this type, for example, has no seams, so that the fluid may move, tightly sealed, within the flat tube.

In an embodiment, the plastic tube can be designed as a multichamber tube, which includes multiple fluid channels which are separated from each other. In terms of its geometry, the multichamber tube can have a cuboid design, so that it may be easily disposed between the individual cells of the lithium-ion battery for the purpose of absorbing the heat output by the individual cells of the lithium-ion battery and removing it from the area of the individual cells with the aid of the fluid flowing through the fluid channels, whereby the heat exchange is further improved. The use of multiple, separate fluid channels permits a transfer of heat over a wide area and a rapid removal of the absorbed heat. A multichamber tube of this type, which can be made of plastic, may be easily manufactured in a single process step, which further reduces the manufacturing costs of the heat exchanger.

In an embodiment, the plastic tube can be made of a plastic which includes heat-conductive particles, for example, ceramic particles. With the aid of ceramic particles of this type, the heat conductivity of the plastic is increased, whereby the heat exchanger may be used in environments having a particularly high temperature.

Alternatively, metal inserts are provided in the interior of the plastic tube for improving the heat conductivity. With the aid of such metal inserts as well, the heat conductivity of the heat exchanger is arbitrarily increased.

In an embodiment, the fluid collector can include two welded, injection-molded parts. The fluid collector comprising plastic shells may be easily manufactured, since the parts, injection-molded from plastic, are connected to each other in only one welding operation. Various methods are known, by which the fluid collector may be welded. These are laser welding, vibration welding or ultrasonic welding. In each case, the fluid collector is manufactured in only one single operation, which reduces the assembly complexity.

In an embodiment, the fluid collector and a connecting element are injection-molded directly onto the ends of the tubes in an overmolding process. The overmolding process is a special injection-molding process, in which two compatible materials may be integrally connected to each other, e.g., using the same matrix but different fillers.

The first and second fluid collectors can be made of the same plastic, for example, the plastic from which the plastic tube is made. By using one and the same plastic for the different elements of the heat exchanger, it is possible to manufacture the heat exchanger with integral connections, for example in the overmolding process described above. It is advantageous if the fluid collector is integrally connected to the plastic tube in an overmolding process.

In an embodiment, the first fluid collector is manufactured from a first plastic, while the second fluid collector is manufactured from a second plastic. In selecting the plastic, the installation site of the heat exchanger may thus be taken into account, in particular if the fluid collector must have a greater strength.

In an embodiment, the first fluid collector and/or the second fluid collector is/are made of a plastic which is free of heat-conductive particles. This is advantageous, in particular, whenever the fluid collector is disposed outside the heat-producing battery cells and is used only to collect and remove the fluid coming from the plastic tubes or to introduce it into the plastic tubes. A heat exchanger of this type, which is fully functionally manufactured from plastic, may be implemented in various component lengths.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a heat exchanger according to the invention;

FIG. 2 shows a detail of the heat exchanger according to the invention according to FIG. 1;

FIG. 3 shows a cross section of the heat exchanger according to the invention according to FIG. 1;

FIG. 4 shows an exemplary embodiment of the heat exchanger according to the invention;

FIG. 5 shows a detail of the heat exchanger according to the invention according to FIG. 4;

FIG. 6 shows a cross section of the heat exchanger according to the invention according to FIG. 4.

### DETAILED DESCRIPTION

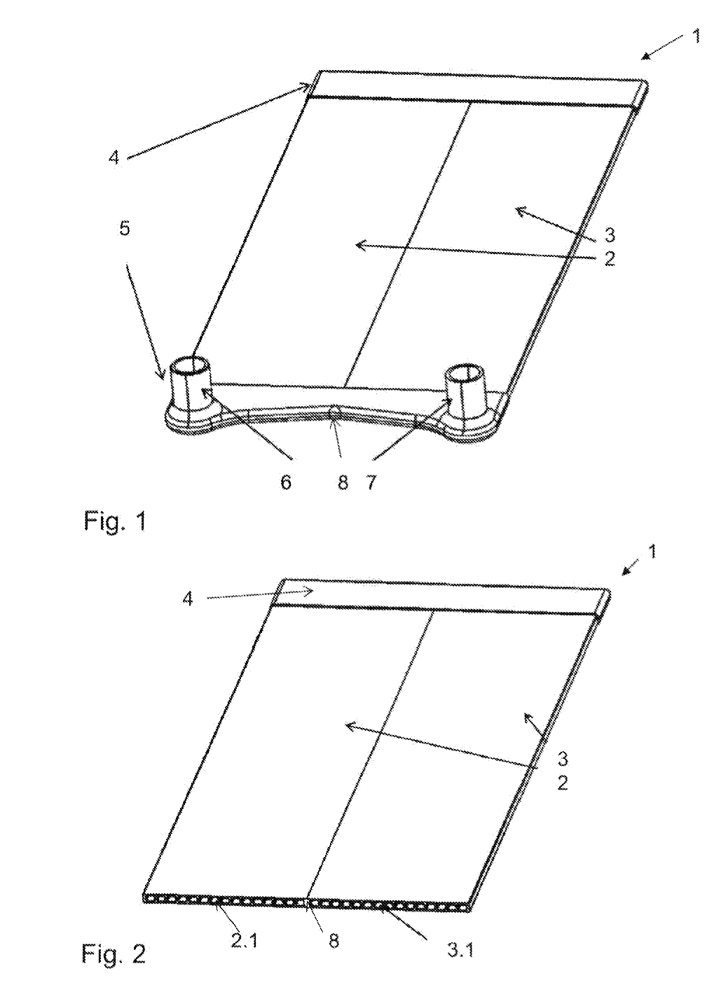

FIG. 1 shows an exemplary embodiment of a heat exchanger 1 according to the invention. Heat exchanger 1 comprises two multichamber tubes 2, 3, which are disposed between two fluid collectors 4, 5. Both multichamber tubes 2, 3 as well as the two fluid collectors 4, 5 are made entirely of plastic. Heat exchanger 1 illustrated in FIG. 1 is designed as a U-flow cooler. A heat exchanger 1 of this type is characterized in that an inlet connector 6 for the fluid designed as a coolant and an outlet connector 7 for the fluid are both disposed on the same fluid collector 5. Inlet connector 6 is disposed in the area of first multichamber tube 2, while outlet connector 7 is opposite second multichamber tube 3.

FIG. 2 shows a detail of multichamber tubes 2 and 3, it being apparent therefrom that each multichamber tube 2, 3 has a plurality of fluid channels 2.1 and 3.1, respectively. In the U-flow cooler described, the fluid flowing through inlet connector 6 via fluid collector 5 into multichamber tube 2 is conducted in channels 2.1 thereof and supplied to second fluid collector 4. In second fluid collector 4, the fluid is deflected and conducted through second multichamber tube 3, in particular its fluid channels 3.1, back to first fluid collector 5, where it is collected and removed from heat exchanger 1 through outlet connector 7. To maintain the circuit between the fluid streams flowing in opposite directions, a partition wall 8 is provided within first fluid collector 5 in the area of the abutment between first and second multichamber tubes 2, 3, which prevents the fluid to be introduced, which is already in fluid collector 5, from entering channels 3.1.

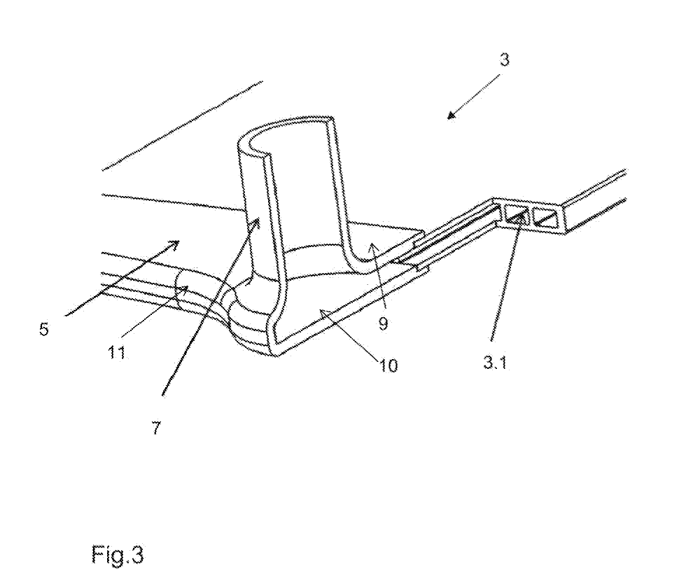

A cross-sectional view of fluid collector 5 in the area of second multichamber tube 3 is illustrated in FIG. 3. It is apparent therefrom that fluid collector 5 is disposed on multichamber tube 3 in such a way that the fluid exiting from fluid channel 3.1 may flow unobstructed into fluid collector 5 and, from there, into outlet connector 7. To implement this, fluid collector 5 is constructed as a box-like container, two approximately parallel walls 9, 10 being connected to each other via a welded joint 11. The two walls 9, 10 are spaced a distance apart which approximately corresponds to the height of particular fluid channels 3.1.

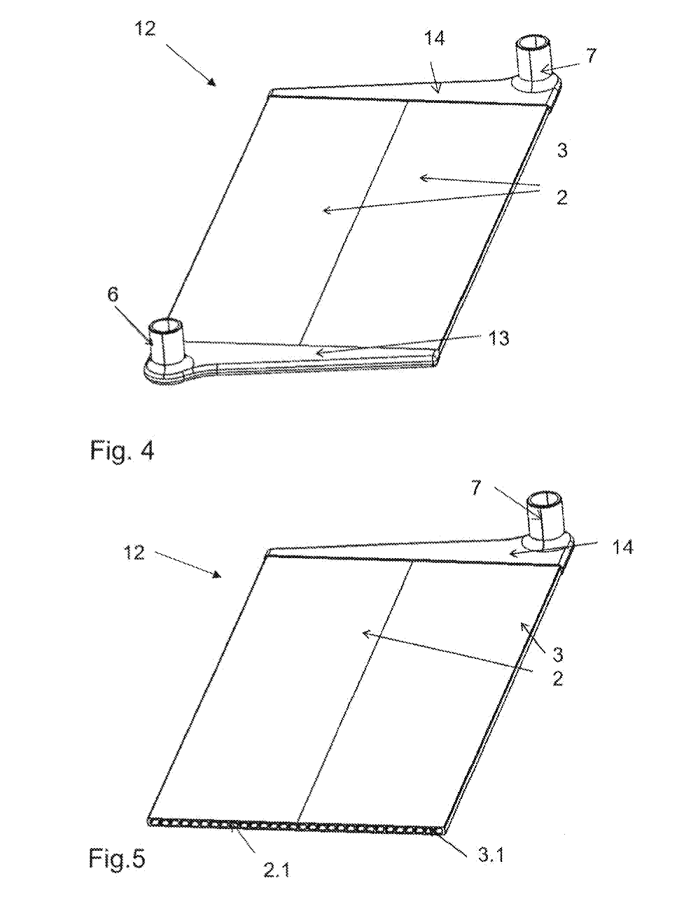

FIG. 4 shows an exemplary embodiment of the heat exchanger 12 according to the invention. This heat exchanger 12 is designed as an I-flow cooler and also comprises two multichamber tubes 2, 3. In this case as well, the two multichamber tubes 2, 3 are sealed on each end by one fluid collector 13, 14. Multichamber tubes 2, 3 and fluid collectors 13, 14 are made entirely of plastic. The I-flow cooler differs from the U-flow cooler in that the two connectors 6, 7 are distributed on both fluid collectors 13, 14. Thus, first fluid collector 13 has inlet connector 6, while second fluid collector 14 supports outlet connector 7. The two fluid collectors 13, 14 are mounted on multichamber tubes 2, 3 in such a way that inlet connector 6 and outlet connector 7 are diagonally opposite each other.

As is apparent from FIG. 5, each multichamber tube 2, 3 has a plurality of fluid channels 2,1 and 3.1, respectively, in this exemplary embodiment as well. In the I-flow cooler, the fluid, which enters fluid collector 13 through connector 6, flows through both multichamber tubes 2, 3 and into second fluid collector 14, where it is collected and leaves heat exchanger 12 via outlet connector 7.

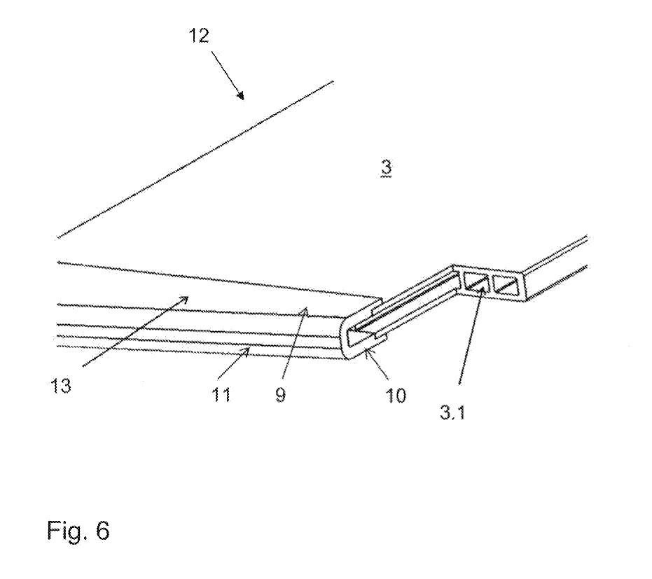

A sectional view of fluid collector 13 and multichamber tube 3 is illustrated in FIG. 6, where it is apparent that, in this case as well, fluid collector 13 comprises two walls 9, 10, which are connected to each other via welded joint 11. The open side of fluid collector 13 is mounted on multichamber tube 3, the inner distance between the two parallel walls 9, 10 of fluid collector 13 having approximately the same distance as the height of fluid channel 3.1. Due to a design of this type, the fluid designed as coolant, which flows into fluid collector 13, may flow unobstructed into fluid channels 2.1 and 3.1, respectively, of the two multichamber tubes 2, 3. Fluid collector 13 is designed without a partition wall. Fluid collector 14 has a comparable structure.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat exchanger for cooling a vehicle battery for hybrid or electric vehicles, the heat exchanger comprising:
at least one cooling element formed as a plastic tube; and
at least one first fluid collector that is made of plastic and that is connected to the cooling element,
wherein, via the cooling element, a fluid is conducted from the first fluid collector to a second fluid collector.

2. The heat exchanger according to claim 1, wherein the plastic tube is an extruded flat tube.

3. The heat exchanger according to claim 1, wherein the plastic tube is a multichamber tube, which includes multiple fluid channels that are separated from each other.

4. The heat exchanger according to claim 1, wherein the plastic tube is made of a plastic that has heat-conductive particles or ceramic particles.

5. The heat exchanger according to claim 1, wherein metal inserts are provided in an interior of the plastic tube for improving the heat conductivity.

6. The heat exchanger according to claim 1, wherein the first or second fluid collector comprises two welded, injection-molded parts.

7. The heat exchanger according to claim 1, wherein the fluid collector is integrally connected to the plastic tube in an overmolding process.

8. The heat exchanger according to claim 1, wherein the first and second fluid collectors are made of the same plastic or made of the plastic from which the plastic tube is made.

9. The heat exchanger according to claim 1, wherein the first fluid collector is made of a first plastic, while the second fluid collector is made of a second plastic that is different than the first plastic.

10. The heat exchanger according to claim 1, wherein the first and/or the second fluid collectors are made of a plastic which is free of heat-conductive particles.
